(19) United States
(12) Patent Application Publication
(10) Pub. No.: US 2022/0307848 A1
(43) Pub. Date: Sep. 29, 2022

(54) AUTONOMOUS VEHICLE PASSENGER DESTINATION DETERMINATION

(71) Applicant: GM Cruise Holdings LLC, San Francisco, CA (US)

(72) Inventors: Alexander Willem Gerrese, San Francisco, CA (US); Jeremy Stephen Juel, San Francisco, CA (US); Aakanksha Mirdha, San Francisco, CA (US); Yifei Zhang, San Francisco, CA (US)

(73) Assignee: GM Cruise Holdings LLC, San Francisco, CA (US)

(21) Appl. No.: 17/210,628

(22) Filed: Mar. 24, 2021

(51) Int. Cl. G01C 21/34; G08G 1/00; B60W 60/00; G08G 1/127

(52) U.S. Cl. CPC G01C 21/3453; G08G 1/22; B60W 60/001; G08G 1/127; B60W 2556/65; B60W 2556/50

(57) ABSTRACT

Systems and methods for determining a passenger destination given a destination type. In particular, based on one or more conditions, a rideshare application selects one or more destination options for the user, and presents the one or more destination options to the user. The conditions can include user input criteria such as type of destination, pricing, and popularity, and external factors such as time of day and traffic.

### FIELD OF THE DISCLOSURE

The present disclosure relates generally to autonomous vehicles (AVs) and to systems and methods for determining passenger destinations.

### BACKGROUND

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. The vehicles can also be used to pick up packages and/or other goods and deliver the packages and/or goods to selected destinations.

Vehicles are often used to provide rides to passengers who are visiting a new city and may be open to suggestions regarding places and restaurants to visit. Additionally, vehicles are often used to provide rides to groups of passengers, and members of a group may disagree on where to go. Generally, passengers search the internet, use applications, and/or consult guide books to decide on a specific destination before ordering a vehicle.

### SUMMARY

Systems and methods are provided determining a passenger destination given a destination type. In particular, based on one or more conditions, a rideshare application selects one or more destination options for the user, and presents the one or more destination options to the user. The conditions can include user input criteria such as type of destination, pricing, and popularity, and external factors such as time of day and traffic.

According to one aspect, a method is provided for selecting a passenger destination, comprising: receiving a request for destination determination, wherein the request includes a pick-up location; receiving at least one destination parameter; evaluating data from a fleet of autonomous vehicles, wherein the data includes routing data for a plurality of autonomous vehicles in the fleet; and selecting the passenger destination based on the at least one destination parameter, the pick-up location, and the data from the fleet. In some implementations, evaluating data from the fleet of autonomous vehicles includes identifying at least one assigned route that runs near the pick-up location.

According to another aspect, a system is provided for autonomous vehicle passenger destination selection, comprising an online portal configured to receive a destination determination request including a destination type and a pick-up location, and a central computing system. The central computing system is configured to receive the destination determination request, evaluate data from a fleet of autonomous vehicles, and select a passenger destination based on the destination type, the pick-up location, and the data from the fleet. The data includes routing data for a plurality of autonomous vehicles in the fleet. In some implementations, the central computing system is further configured to identify, from the data, at least one assigned route that runs near the pick-up location.

According to another aspect, a system is provided for selecting passenger destinations in an autonomous vehicle fleet, comprising a plurality of autonomous vehicles, and a central computer in communication with the plurality of autonomous vehicles. The central computer includes a routing coordinator configured to collect position data and manage routing data from each of the plurality of autonomous vehicles. The central computer is configured to receive a destination determination request including a pick-up location. The routing coordinator is configured to evaluate the position data and the routing data, identify a first assigned route corresponding to the request, and select a passenger destination for the request based on the first assigned route.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

To provide a more complete understanding of the present disclosure and features and advantages thereof, reference is made to the following description, taken in conjunction with the accompanying figures, wherein like reference numerals represent like parts, in which:

FIG. 1 is a diagram illustrating an autonomous vehicle, according to some embodiments of the disclosure;

FIG. 2 is a diagram illustrating a method for determining a passenger destination, according to some embodiments of the disclosure;

FIG. 3 is a diagram illustrating a method for selecting a passenger destination, according to some embodiments of the disclosure;

FIG. 4 is a diagram illustrating a fleet of autonomous vehicles in communication with a central computer, according to some embodiments of the disclosure;

FIGS. 5A-5C show examples of an interface for passenger destination determination according to some embodiments of the disclosure; and

FIG. 6 shows an example embodiment of a system for implementing certain aspects of the present technology.

### DETAILED DESCRIPTION

### Overview

Systems and methods are provided for determining a passenger destination given a destination type. In particular, systems and methods are provided for a rideshare service, such as an autonomous vehicle rideshare service, to provide a user with a specific destination location given selected inputs. In some examples, people can suffer from decision fatigue when selecting a destination to visit, and prefer to have a destination or a destination suggestion provided to them.

One example is deciding where to eat, since the sheer variety and number of options makes proposing a plan difficult, especially if a user is in a new location or if there are multiple people in the party. For example, a user who is visiting a new city may want to go out for dinner and not know which restaurant to go to. In some cases, there is little resistance to a proposed plan, but it is difficult to select from the large variety of restaurants, cafés, and other eateries.

In another example, tourists or other travelers to a city want to visit sight-seeing locations and/or popular hole-in-the-wall destinations, but don't know what day and/or time of day is good to visit various locations. Additionally, the tourist or travelers may not know where they are in relation to other interesting destinations, or where is convenient to visit next based on a current location. Travel information services and general search engines can exacerbate the problem by providing too much information and too many choices.

Additionally, outside of advertisements, local businesses have few options for directly reaching potential customers. Systems and methods provided herein can provide businesses with the opportunity to have potential customers delivered to their front door via a rideshare service.

According to various implementations, systems and methods are provided for a user to input a destination type into a rideshare application and for the rideshare application to propose and/or select a specific destination for the user. In some examples, the rideshare application proposes more than one specific destination, and the user selects from the proposals. In other examples, the rideshare application proposes one destination, and the user has an option to accept the destination or to request another proposal. In some examples, the destination type includes one of a restaurant, a sight-seeing destination, and an entertainment venue. In some examples, the user can select a price range, a distance to drive from the current location, and/or a type of cuisine (for a restaurant). In some examples, the rideshare service considers routing coordination factors, such as the time of day, current traffic conditions, weather, and previous user destinations.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

Example Autonomous Vehicle Configured for Passenger Destination Determination

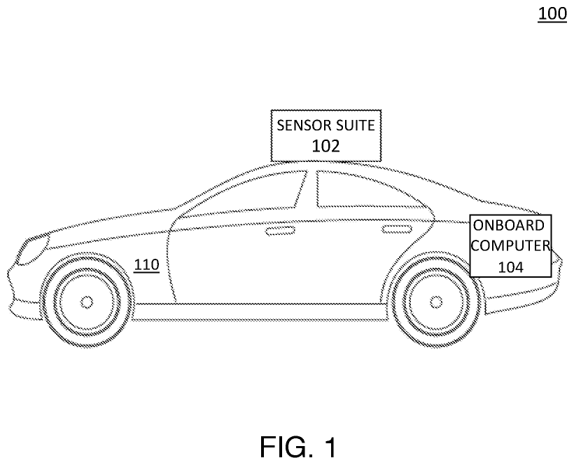

FIG. 1 is a diagram 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. The autonomous vehicle 110 is configured for passenger destination determination via a rideshare application.

The sensor suite 102 includes localization and driving sensors. For example, the sensor suite may include one or more of photodetectors, cameras, RADAR, SONAR, LIDAR, GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment and, in some examples, sensor suite 102 data is used to detect selected events. In particular, data from the sensor suite 102 can be used to update a map with information used to develop layers with waypoints identifying selected events, the locations of the encountered events, and the frequency with which the events are encountered at the identified location. In some examples, data from the sensor suite 102 can include information regarding crowds and/or lines outside and/or around selected venues. Additionally, sensor suite 102 data can provide localized traffic information. In this way, sensor suite 102 data from many autonomous vehicles can continually provide feedback to the mapping system and the high fidelity map can be updated as more and more information is gathered.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. In some examples, the interior sensors can be used to detect passengers inside the vehicle. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

Example Method for Determining Passenger Destination

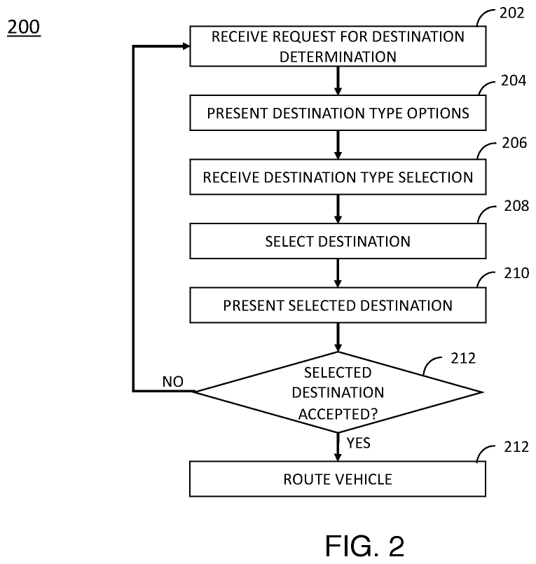

FIG. 2 is a diagram illustrating a method 200 for determining a passenger destination, according to some embodiments of the disclosure. At step 202, a destination determination request is received. Then, at step 204, destination type options are presented to the user. In some examples, the destination type includes one of a restaurant, a live event, arts, sight-seeing, a service, and a nature/outdoor locale.

In some examples, the destination type includes a destination sub-type. For example, a restaurant selection includes a sub-selection of a cuisine or food category type, such as steakhouse, tex-mex, pizza, burgers, ice cream, seafood, Chinese food, Thai food, Indian food, vegetarian, gluten-free, etc. In another example, a service destination type includes a service type, such as dry-cleaning, pharmacy, groceries, liquor store, etc. Similarly, a live event selection includes a sub-selection of an event type, such as a live music event, art show, an outdoor event, an indoor event, a public event, etc. A nature/outdoor locale can include a sub-selection of a running/walking trail, terrain type, beach, mountain, viewpoint, etc.

In addition to destination type, in some implementations, a user can also specify other conditions such as a price range for the cost at the destination location, distance to the destination location, and crowdedness of the destination location.

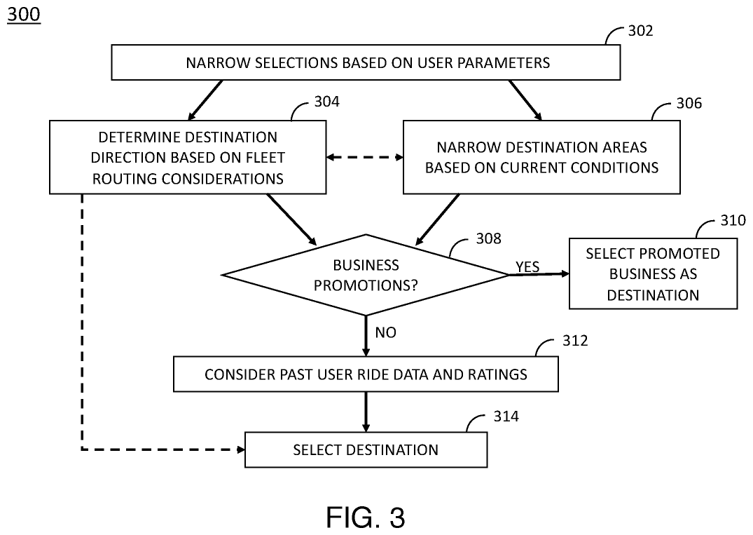

At step 206, the destination type selection is received. The destination type is used to narrow down the destination to be selected. At step 208, the destination is selected, as described in greater detail with respect to FIG. 3. In addition to considering the user destination type selections, other factors are also considered. Examples of other factors that can be considered include the time of day, the weather, the current live traffic, past trips (both for the user and for other users), trip patterns, and data from fleet vehicle sensor suites. Furthermore, fleet routing data can be considered such that a destination causes a vehicle to drive to a selected area where the routing coordinator expects the vehicle to be used next.

Once a destination location is determined, at step 210 the selected destination is presented to the user device. In some examples, two destination options are presented to the user. In some examples, a main destination location is presented to the user and an alternative “back-up” destination location is also presented. In various examples, the user can accept the selected destination or reject the destination. At step 212, it is determined whether the selected destination was accepted. If the selected destination was accepted, at step 212, a vehicle is directed to a pick-up location and further routed to the selected destination location. If the selected destination was not accepted at step 212, the method either ends, or returns to step 202, where it begins again.

FIG. 3 is a diagram illustrating a method 300 for selecting a passenger destination, according to some embodiments of the disclosure. In particular, the diagram 300 provides additional details for step 208 of FIG. 2. In some examples, a central computer performs the method 300. In some examples, a routing coordinator performs a routing algorithm according to the method 300. Once a user request for destination selection is received, at step 302, potential destination selections are narrowed based on user destination parameters. As discussed above, user parameters include destination type, price range, and distance, and can include a destination sub-type or other designation.

Once the selections are narrowed in step 302, the method proceeds to steps 304 and 306. In some examples, steps 304 and 306 are performed concurrently. In some examples, steps 304 and 306 are performed consecutively, and either step 304 or step 306 can be performed first. In some examples, step 304 results directly in a destination selection, and steps 306, 308, and 312 are skipped. At step 304, the destination direction is determined based on fleet routing considerations.

In one example, the selected destination is determined to coincide with another known ride request, such that the ride to the selected destination can be a shared ride with the known ride request. The selected destination can be the same destination as the known ride request, or it can be a destination close to the destination of the known ride request. For example, user A is in a first vehicle en route to a TexMex restaurant when user B uses the passenger destination determination feature to find a restaurant close by. User B's pick-up location is within an acceptable matching range for the first vehicle, and the TexMex restaurant satisfies user B's request conditions, so user B is added to the same ride as user A, in the first vehicle. In particular, assigned routes for the autonomous vehicles in the fleet can be evaluated to identify any assigned routes that run near User B's pick-up location. Additionally, assigned routes for the autonomous vehicles in the fleet can be evaluated to identify any assigned routes that that correspond with User B's request conditions. This allows the rideshare service to capture the value of two riders for the occupancy and routing price of one rider. The alternative is to route user B to another restaurant either in the same vehicle or in a different vehicle, eliminating some of the routing efficiency. In this example, the possibility of adding rider B to a current ride takes precedence over other factors, such as those discussed with respect to steps 306, 308, and 312, below, and the destination can be selected directly based on routing considerations at step 304.

In another example, a selected direction may be prioritized to help balance the fleet by moving vehicles from a first location to a second location, where there are more than enough vehicles in the first location to service the area, and fewer vehicles in the second location than ideal.

At step 306, destination areas are narrowed based on current conditions. The current conditions include one or more of current traffic, predicted/expected traffic, road conditions, weather, time of day, and safety ratings. For example, roads with moderate to heavy traffic may be avoided. Additionally, roads that are expected to have moderate to heavy traffic based on daily data and/or current routes may be avoided. In some examples, routes from a city to the suburbs in the afternoon and evening commuting hours are expected to have heavy traffic and are avoided during that time period. Similarly, in some examples, routes from the suburbs toward a city are expected to have heavy traffic during the morning commuting hours are avoided during that time period.

Road conditions that are considered at step 306 can include ongoing roadwork, recent accidents, slippery roads, pot holes, and other road hazards. Additionally, weather can be considered in order to avoid localized storms, snow, ice, and heavy downpours. In one example, a storm may cause snow and icy roads in one area, but rain a few miles away, depending on where the rain/snow line is. Safety ratings that are considered can include personal safety as well as vehicle safety. For example, if there is a high rate of crime in a selected area, it may be avoided in the interest of passenger safety. In one example, if the high rate of crime is generally only in the evening and/or at night, the area may be avoided during those time periods.

At step 306, information about current conditions can also include information from other vehicles in the rideshare vehicle fleet. In some examples, there are fleet vehicles in the vicinity of selected destinations, and sensor suite data from the other vehicles can be used to provide additional current context about how the location appears, such as whether a location is busy, if there is a line to get in to a specific destination location, what the weather conditions are, and/or any other local conditions that may be present. The sensor suite data may be live data and/or it may be fairly recent, e.g., within a selected period of time.

Once a general destination area or areas is determined based on steps 304 and 306, at step 308, business promotions are reviewed. In particular, in some implementations, one or more local businesses contract with the rideshare service to be promoted as selected destinations, such that when a contracted business fits the destination selection criteria, the business is selected for the rideshare user. In this way, businesses can increase the probability that the routing algorithm will select their business as a destination. At step 308, if there is a business that has contracted with the rideshare company to be promoted that fits the criteria and conditions of steps 302, 304, and 306, the method 300 proceeds to step 310, and that business is selected as the destination. In some examples, a business is promoted only a certain number of times per hour, per evening, per day, or during some other selected time period, and after that number of rides to the business have been fulfilled, the business is not promoted as a destination for future users until the time period has been reset.

If, at step 308, there are no businesses to be promoted that fit within the selection criteria and factors from steps 302, 304, and 306, the method 300 proceeds to step 312, and past user ride data and ratings are considered. Both ride data and ratings from the current user's past rides and ride data and ratings from other users can be considered at step 312. For example, the current user may have a history of ordering rides to brunch locales on Saturday mornings. The user's past restaurant choices can be considered in selecting a current destination. In some examples, a user has used the passenger destination determination feature multiple times, and rated multiple destination selections and the user's past ratings are considered in selecting a new destination. Similarly, other users' ratings can be considering in selecting a destination, for example to avoid destinations with low satisfaction ratings, and/or to select destinations with high satisfaction ratings. In some examples, other rating platforms can be used to evaluate user ratings. For example, the rideshare service can consult search engine ratings or specific ratings applications for generalized user ratings of various destinations.

At step 314, a destination is selected from the set of viable options that remain after the previous method steps. In some examples, the destination is selected at random from the set of possible destinations.

In other implementations, past user ride data such as historical trips and time of day can be used to suggest a destination proactively, before a destination determination method is initiated. For example, if a user often goes to museums on Sunday mornings, a new museum can be suggested to the user as a potential destination via a notification, a message, and/or on the homepage of the app.

Example of Autonomous Vehicle Fleet

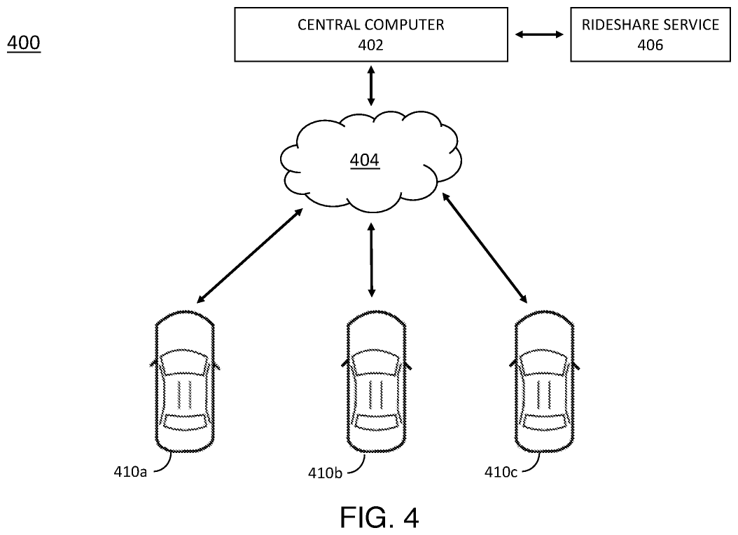

FIG. 4 is a diagram 400 illustrating a fleet of autonomous vehicles 410a, 410b, 410c in communication with a central computer 402, according to some embodiments of the disclosure. As shown in FIG. 4, the vehicles 410a-410c communicate wirelessly with a cloud 404 and a central computer 402. The central computer 402 includes a routing coordinator and a database of information from the vehicles 410a-410c in the fleet. Autonomous vehicle fleet routing refers to the routing of multiple vehicles in a fleet. The central computer also acts as a centralized ride management system and communicates with a rideshare users via a rideshare service 406. Via the rideshare service 406, the central computer can implement a passenger destination determination method. In some implementations, the autonomous vehicles 410a-410c communicate directly with each other.

When a destination determination request is entered at a rideshare service 406, the rideshare service 406 sends the request to central computer 402. The central computer 402 selects a destination based on the request, as described above with respect to the methods of FIGS. 2 and 3. The central computer 402 uses information from the autonomous vehicles 410a-410c in the autonomous vehicle fleet to select the destination. In some examples, when a user accepts a destination determination, the vehicle to fulfill the request is selected and route for the vehicle is generated by the routing coordinator. In other examples, the routing coordinator provides the vehicle 410a-410c with a set of parameters and the vehicle 410a-410c generates an individualized specific route. The generated route includes a route from the autonomous vehicle's 410a-410c present location to the pick-up location, and a route from the pick-up location to the final destination. Each of the autonomous vehicles 410a, 410b, 410c in the fleet are equipped to participate in providing rides via passenger destination determination requests as described with respect to FIGS. 2 and 3. The vehicles 410a, 410b, 410c communicate with a central computer 402 via a cloud 404.

Once a destination is selected and the user has ordered a vehicle, the routing coordinator can optimize the routes to avoid traffic as well as vehicle occupancy. In some examples, an additional passenger can be picked up en route to the destination, and the additional passenger can have a different destination. In various implementations, since the routing coordinator has information on the assigned routes for all the vehicles in the fleet, the routing coordinator can adjust vehicle routes to reduce congestion and increase vehicle occupancy.

As described above, each vehicle 410a-410c in the fleet of vehicles communicates with a routing coordinator. Thus, information gathered by various autonomous vehicles 410a-410c in the fleet can be saved and used to generate information for future routing determinations. For example, sensor data can be used to generate route determination parameters. In general, the information collected from the vehicles in the fleet can be used for route generation or to modify existing routes. In some examples, the routing coordinator collects and processes position data from multiple autonomous vehicles in real-time to avoid traffic and generate a fastest-time route for each autonomous vehicle. In some implementations, the routing coordinator uses collected position data to generate a best route for an autonomous vehicle in view of one or more travelling preferences and/or routing goals. In some examples, the routing coordinator uses collected position data corresponding to emergency events to generate a best route for an autonomous vehicle to avoid a potential emergency situation.

According to various implementations, a set of parameters can be established that determine which metrics are considered (and to what extent) in determining routes or route modifications. For example, expected congestion or traffic based on a known event can be considered. Generally, a routing goal refers to, but is not limited to, one or more desired attributes of a routing plan indicated by at least one of an administrator of a routing server and a user of the autonomous vehicle. The desired attributes may relate to a desired duration of a route plan, a comfort level of the route plan, a vehicle type for a route plan, safety of the route plan, and the like. For example, a routing goal may include time of an individual trip for an individual autonomous vehicle to be minimized, subject to other constraints. As another example, a routing goal may be that comfort of an individual trip for an autonomous vehicle be enhanced or maximized, subject to other constraints.

Routing goals may be specific or general in terms of both the vehicles they are applied to and over what timeframe they are applied. As an example of routing goal specificity in vehicles, a routing goal may apply only to a specific vehicle, or to all vehicles in a specific region, or to all vehicles of a specific type, etc. Routing goal timeframe may affect both when the goal is applied (e.g., some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

Some examples of routing goals include goals involving trip duration (either per trip, or average trip duration across some set of vehicles and/or times), physics, laws, and/or company policies (e.g., adjusting routes chosen by users that end in lakes or the middle of intersections, refusing to take routes on highways, etc.), distance, velocity (e.g., max., min., average), source/destination (e.g., it may be optimal for vehicles to start/end up in a certain place such as in a pre-approved parking space or charging station), intended arrival time (e.g., when a user wants to arrive at a destination), duty cycle (e.g., how often a car is on an active trip vs. idle), energy consumption (e.g., gasoline or electrical energy), maintenance cost (e.g., estimated wear and tear), money earned (e.g., for vehicles used for ridesharing), person-distance (e.g., the number of people moved multiplied by the distance moved), occupancy percentage, higher confidence of arrival time, user-defined routes or waypoints, fuel status (e.g., how charged a battery is, how much gas is in the tank), passenger satisfaction (e.g., meeting goals set by or set for a passenger) or comfort goals, environmental impact, passenger safety, pedestrian safety, toll cost, etc. In examples where vehicle demand is important, routing goals may include attempting to address or meet vehicle demand.

Routing goals may be combined in any manner to form composite routing goals; for example, a composite routing goal may attempt to optimize a performance metric that takes as input trip duration, rideshare revenue, and energy usage and also, optimize a comfort metric. The components or inputs of a composite routing goal may be weighted differently and based on one or more routing coordinator directives and/or passenger preferences.

Likewise, routing goals may be prioritized or weighted in any manner. For example, a set of routing goals may be prioritized in one environment, while another set may be prioritized in a second environment. As a second example, a set of routing goals may be prioritized until the set reaches threshold values, after which point a second set of routing goals take priority. Routing goals and routing goal priorities may be set by any suitable source (e.g., an autonomous vehicle routing platform, an autonomous vehicle passenger).

The routing coordinator uses maps to select an autonomous vehicle from the fleet to fulfill a ride request. In some implementations, the routing coordinator sends the selected autonomous vehicle the ride request details, including pick-up location and destination location, and an onboard computer on the selected autonomous vehicle generates a route and navigates to the destination. In some implementations, the routing coordinator in the central computing system 402 generates a route for each selected autonomous vehicle 410a-410c, and the routing coordinator determines a route for the autonomous vehicle 410a-410c to travel from the autonomous vehicle's current location to a first destination.

Example of a Passenger Destination Determination Interface

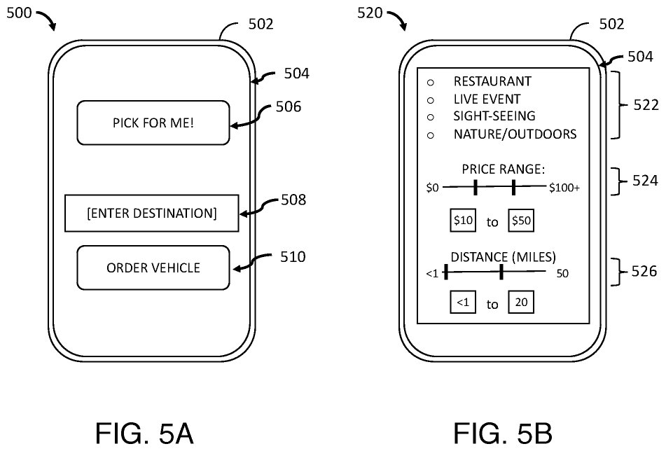

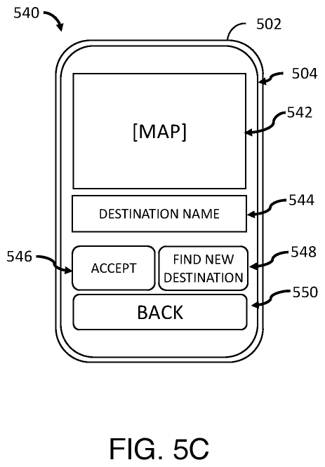

FIGS. 5A-5C show examples 500, 520, 540 of an interface for passenger destination determination, according to some embodiments of the disclosure. FIG. 5A shows an example 500 of a device 502 showing a home screen 504 for a rideshare application. In particular, the home screen 504 provides a user with two options: a destination determination option via the “Pick For Me” button 506, and an option to enter a specific destination in text box 508 and order a vehicle to the destination via an “order vehicle” button 510. In various implementations, the home screen 504 can include other options, such as an account overview option, a setting option, etc.

When a user selects the “Pick For Me” button 506, the rideshare service generates a destination as described above with respect to method 200 of FIG. 2 and method 300 of FIG. 3. FIG. 5B shows an example 520 of a rideshare service interface for a user to provide additional information regarding the destination determination. In particular, FIG. 5B shows the rideshare app screen following the “Pick For Me” button request. In a first section 522, a user can select among one of four destination type options: restaurant, live event, sight-seeing, nature/outdoors. In a second section 524, a user can specify a price range for the destination. The second section 524 includes a sliding scale, in which the user can slide the vertical elements to specify the price range, with the corresponding price reflected in the boxes underneath. Alternatively, a user can enter the upper and lower prices directly in the price range boxes. In a third section 526, a user can specify a distance to the destination. The third section 526 includes a sliding scale, in which the user can slide vertical elements to specify the distance, with the corresponding distances reflected in the boxes underneath. Alternatively, a user can enter the distances directly in the distance boxes.

In various implementations, the interface in FIG. 5B can include additional options, and it may not include the options shown. In some examples, the interface includes a destination city, destination direction, and/or a destination zip code. Then, for example, if a user wants to visit a restaurant before a scheduled event, the user can select the destination determination option and allow the rideshare application to select the restaurant, while also specifying that the trip to the restaurant brings the user closer to the event location. Additionally, in some implementations, following the interface in FIG. 5B, there is another interface in which the user provides further specifications about the destination, such as restaurant cuisine type, as described above.

Once the destination parameters are provided by the user, the rideshare service selects a destination as described above with regards to FIGS. 2 and 3. FIG. 5C shows an example 540 of a rideshare service interface showing the destination selection. In particular, the rideshare app displays the destination name 544 and the destination location on the map 542. The map 542 may also show the user device location. The interface presents three options to the user. A first option is to accept the selected destination by selecting the “accept” button 546. A second option is to reject the selected destination and request a new destination selection by selecting the “find new destination” button. A third option is to return to the main homepage via the “back” button 550. In other examples, the destination determination algorithm returns two possible destination, and both destinations are listed in the destination name box 544 and shown on the map 542. The user can then choose one of the destination selections, request new destination selections, or return to the homepage.

Example of a Computing System for Ride Requests

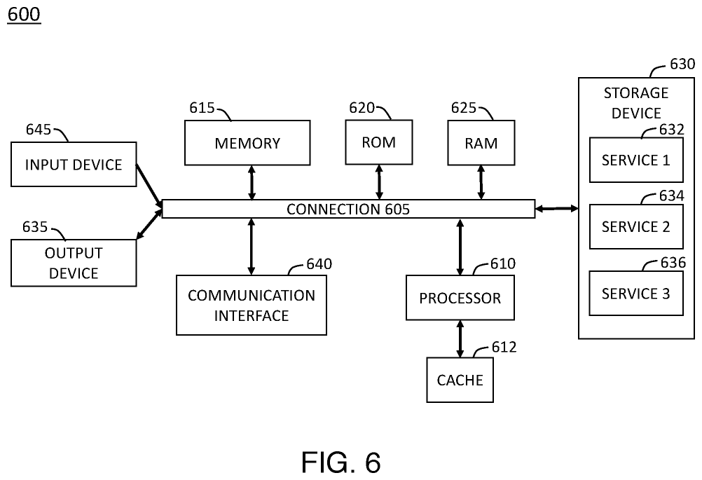

FIG. 6 shows an example embodiment of a computing system 600 for implementing certain aspects of the present technology. In various examples, the computing system 600 can be any computing device making up the onboard computer 104, the central computing system 402, or any other computing system described herein. The computing system 600 can include any component of a computing system described herein which the components of the system are in communication with each other using connection 605. The connection 605 can be a physical connection via a bus, or a direct connection into processor 610, such as in a chipset architecture. The connection 605 can also be a virtual connection, networked connection, or logical connection.

In some implementations, the computing system 600 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

The example system 600 includes at least one processing unit (CPU or processor) 610 and a connection 605 that couples various system components including system memory 615, such as read-only memory (ROM) 620 and random access memory (RAM) 625 to processor 610. The computing system 600 can include a cache of high-speed memory 612 connected directly with, in close proximity to, or integrated as part of the processor 610.

The processor 610 can include any general-purpose processor and a hardware service or software service, such as services 632, 634, and 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction, the computing system 600 includes an input device 645, which can represent any number of input mechanisms, such as a microphone for speech, a touch-sensitive screen for gesture or graphical input, keyboard, mouse, motion input, speech, etc. The computing system 600 can also include an output device 635, which can be one or more of a number of output mechanisms known to those of skill in the art. In some instances, multimodal systems can enable a user to provide multiple types of input/output to communicate with the computing system 600. The computing system 600 can include a communications interface 640, which can generally govern and manage the user input and system output. There is no restriction on operating on any particular hardware arrangement, and therefore the basic features here may easily be substituted for improved hardware or firmware arrangements as they are developed.

A storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as a processor 610, a connection 605, an output device 635, etc., to carry out the function.

As discussed above, each vehicle in a fleet of vehicles communicates with a routing coordinator. When a vehicle is flagged for service, the routing coordinator schedules the vehicle for service and routes the vehicle to the service center. When the vehicle is flagged for maintenance, a level of importance or immediacy of the service can be included. As such, service with a low level of immediacy will be scheduled at a convenient time for the vehicle and for the fleet of vehicles to minimize vehicle downtime and to minimize the number of vehicles removed from service at any given time. In some examples, the service is performed as part of a regularly-scheduled service. Service with a high level of immediacy may require removing vehicles from service despite an active need for the vehicles.

Routing goals may be specific or general in terms of both the vehicles they are applied to and over what timeframe they are applied. As an example of routing goal specificity in vehicles, a routing goal may apply only to a specific vehicle, or to all vehicles of a specific type, etc. Routing goal timeframe may affect both when the goal is applied (e.g., urgency of the goal, or, some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

In various implementations, the routing coordinator is a remote server or a distributed computing system connected to the autonomous vehicles via an Internet connection. In some implementations, the routing coordinator is any suitable computing system. In some examples, the routing coordinator is a collection of autonomous vehicle computers working as a distributed system.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### SELECT EXAMPLES

Example 1 provides a method for selecting a passenger destination, comprising: receiving a request for destination determination, wherein the request includes a pick-up location; receiving at least one destination parameter; evaluating data from a fleet of autonomous vehicles, wherein the data includes routing data for a plurality of autonomous vehicles in the fleet; and selecting the passenger destination based on the at least one destination parameter, the pick-up location, and the data from the fleet.

Example 2 provides a method according to one or more of the preceding and/or following examples, wherein evaluating data from the fleet of autonomous vehicles includes identifying at least one assigned route that runs near the pick-up location.

Example 3 provides a method according to one or more of the preceding and/or following examples, further comprising determining whether a route destination of the at least one assigned route corresponds with the at least one destination parameter, wherein, when the route destination corresponds with the at least one destination parameter, selecting the passenger destination comprises selecting the route destination.

Example 4 provides a method according to one or more of the preceding and/or following examples, wherein identifying the at least one assigned route includes identifying a plurality of assigned routes that run near the pick-up location, and further comprising identifying a subset of the plurality of assigned routes wherein route destinations of the subset correspond with the at least one destination parameter; and wherein selecting the passenger destination comprises selecting a first route of the subset and setting the passenger destination as a route destination of the first route.

Example 5 provides a method according to one or more of the preceding and/or following examples, further comprising generating a passenger destination route from the pick-up location to the passenger destination, wherein the route comprises a shared ride with the first route selecting the first route includes randomly selecting the first route from the subset of the plurality of assigned routes.

Example 6 provides a method according to one or more of the preceding and/or following examples, wherein selecting the first route includes randomly selecting the first route from the subset of the plurality of assigned routes.

Example 7 provides a method according to one or more of the preceding and/or following examples, further comprising determining whether any of the route destinations one of a set of promoted businesses.

Example 8 provides a method according to one or more of the preceding and/or following examples, further comprising determining whether a promoted business from a set of promoted businesses satisfies the destination parameter.

Example 9 provides a system for autonomous vehicle passenger destination selection, comprising an online portal configured to receive a destination determination request including a destination type and a pick-up location; and a central computing system configured to receive the destination determination request, evaluate data from a fleet of autonomous vehicles, and select a passenger destination based on the destination type, the pick-up location, and the data from the fleet, wherein the data includes routing data for a plurality of autonomous vehicles in the fleet.

Example 10 provides a system according to one or more of the preceding and/or following examples, wherein the central computing system is further configured to identify, from the data, at least one assigned route that runs near the pick-up location.

Example 11 provides a system according to one or more of the preceding and/or following examples, wherein the central computing system is further configured to determine whether a route destination of the at least one assigned route corresponds with the at least one destination type, wherein, when the route destination corresponds with the at least one destination type, the central computing system is configured to set the passenger destination as the route destination.

Example 12 provides a system according to one or more of the preceding and/or following examples, wherein the central computing system is further configured to: identify a plurality of assigned routes that run near the pick-up location, wherein route destinations of the plurality of assigned routes correspond with the at least one destination type; and select a first route from the plurality of assigned routes, wherein the first route has a first route destination, and wherein central computing system selects the first route destination as the passenger destination.

Example 13 provides a system according to one or more of the preceding and/or following examples, wherein the central computing system is further configured to generate a passenger destination route from the pick-up location to the passenger destination, wherein the passenger destination route comprises a shared ride with the first route.

Example 14 provides a system according to one or more of the preceding and/or following examples, wherein the central computing system is further configured to randomly select the first route from the subset of the plurality of assigned routes.

Example 15 provides a system according to one or more of the preceding and/or following examples, wherein the central computing system is further configured to determine whether any of the route destinations of the plurality of assigned routes is one of a set of promoted businesses.

Example 16 provides a system for selecting passenger destinations in an autonomous vehicle fleet, comprising a plurality of autonomous vehicles, and a central computer in communication with the plurality of autonomous vehicles, including a routing coordinator configured to collect position data and manage routing data from each of the plurality of autonomous vehicles wherein the central computer is configured to receive a destination determination request including a pick-up location, and wherein the routing coordinator is configured to evaluate the position data and the routing data, identify a first assigned route corresponding to the request, and select a passenger destination for the request based on the first assigned route.

Example 17 provides a system according to one or more of the preceding and/or following examples, wherein the routing coordinator is further configured to generate a passenger destination route from the pick-up location to the passenger destination, wherein the passenger destination route comprises, at least in part, a shared ride with the first assigned route.

Example 18 provides a system according to one or more of the preceding and/or following examples, wherein the request includes a destination parameter, and wherein the central computer is further configured to identify a subset of the plurality of autonomous vehicles having a route destination that corresponds with the destination parameter.

Example 19 provides a system according to one or more of the preceding and/or following examples, wherein the routing coordinator is configured to evaluate the position data and the routing data of the subset of the plurality of autonomous vehicles.

Example 20 provides a system according to one or more of the preceding and/or following examples, wherein the central computing system is further configured to store a set of promoted business destinations and identify whether at least one of the set of promoted business destinations corresponds to the request.

Variations and Implementations

According to various examples, driving behavior includes any information relating to how an autonomous vehicle drives. For example, driving behavior includes how and when the autonomous vehicle actuates its brakes and its accelerator, and how it steers. In particular, the autonomous vehicle is given a set of instructions (e.g., a route or plan), and the driving behavior determines how the set of instructions is implemented to drive the car to and from various destinations, and, potentially, to stop for passengers or items. Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, “legal ambiguity” conduct (e.g., in a solid-green left turn situation, whether a vehicle pulls out into the intersection or waits at the intersection line), action profiles (e.g., how a vehicle turns, changes lanes, or performs a driving maneuver), and action frequency constraints (e.g., how often a vehicle changes lanes). Additionally, driving behavior includes information relating to whether the autonomous vehicle drives and/or parks.

As will be appreciated by one skilled in the art, aspects of the present disclosure, in particular aspects of a perception system for an autonomous vehicle, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A method for selecting a passenger destination, comprising:
receiving a request for destination determination, wherein the request includes a pick-up location;
receiving at least one destination parameter;
evaluating data from a fleet of autonomous vehicles, wherein the data includes routing data for a plurality of autonomous vehicles in the fleet; and
selecting the passenger destination based on the at least one destination parameter, the pick-up location, and the data from the fleet.

2. The method of claim 1, wherein evaluating data from the fleet of autonomous vehicles includes identifying at least one assigned route that runs near the pick-up location.

3. The method of claim 2, further comprising:
determining whether a route destination of the at least one assigned route corresponds with the at least one destination parameter,
wherein, when the route destination corresponds with the at least one destination parameter, selecting the passenger destination comprises selecting the route destination.

4. The method of claim 2, wherein identifying the at least one assigned route includes identifying a plurality of assigned routes that run near the pick-up location, and further comprising:
identifying a subset of the plurality of assigned routes wherein route destinations of the subset correspond with the at least one destination parameter; and
wherein selecting the passenger destination comprises selecting a first route of the subset and setting the passenger destination as a route destination of the first route.

5. The method of claim 4, further comprising generating a passenger destination route from the pick-up location to the passenger destination, wherein the route comprises a shared ride with the first route.

6. The method of claim 4, wherein selecting the first route includes randomly selecting the first route from the subset of the plurality of assigned routes.

7. The method of claim 4, further comprising determining whether any of the route destinations is one of a set of promoted businesses.

8. The method of claim 1, further comprising determining whether a promoted business from a set of promoted businesses satisfies the destination parameter.

9. A system for autonomous vehicle passenger destination selection, comprising:
an online portal configured to receive a destination determination request including a destination type and a pick-up location; and
a central computing system configured to receive the destination determination request, evaluate data from a fleet of autonomous vehicles, and select a passenger destination based on the destination type, the pick-up location, and the data from the fleet,
wherein the data includes routing data for a plurality of autonomous vehicles in the fleet.

10. The system of claim 9, wherein the central computing system is further configured to identify, from the data, at least one assigned route that runs near the pick-up location.

11. The system of claim 10, wherein the central computing system is further configured to determine whether a route destination of the at least one assigned route corresponds with the at least one destination type,
wherein, when the route destination corresponds with the at least one destination type, the central computing system is configured to set the passenger destination as the route destination.

12. The system of claim 9, wherein the central computing system is further configured to:
identify a plurality of assigned routes that run near the pick-up location, wherein route destinations of the plurality of assigned routes correspond with the at least one destination type; and
select a first route from the plurality of assigned routes, wherein the first route has a first route destination, and
wherein central computing system selects the first route destination as the passenger destination.

13. The system of claim 12, wherein the central computing system is further configured to generate a passenger destination route from the pick-up location to the passenger destination, wherein the passenger destination route comprises a shared ride with the first route.

14. The system of claim 12, wherein the central computing system is further configured to randomly select the first route from the plurality of assigned routes.

15. The system of claim 12, wherein the central computing system is further configured to determine whether any of the route destinations of the plurality of assigned routes is one of a set of promoted businesses.

16. A system for selecting passenger destinations in an autonomous vehicle fleet, comprising:
a plurality of autonomous vehicles;
a central computer in communication with the plurality of autonomous vehicles, comprising:
a routing coordinator configured to collect position data and manage routing data from each of the plurality of autonomous vehicles,
wherein the central computer is configured to receive a destination determination request including a pick-up location, and
wherein the routing coordinator is configured to evaluate the position data and the routing data, identify a first assigned route corresponding to the request, and select a passenger destination for the request based on the first assigned route.

17. The system of claim 16, wherein the routing coordinator is further configured to generate a passenger destination route from the pick-up location to the passenger destination, wherein the passenger destination route comprises, at least in part, a shared ride with the first assigned route.

18. The system of claim 16, wherein the request includes a destination parameter, and wherein the central computer is further configured to identify a subset of the plurality of autonomous vehicles having a route destination that corresponds with the destination parameter.

19. The system of claim 18, wherein the routing coordinator is configured to evaluate the position data and the routing data of the subset of the plurality of autonomous vehicles.

20. The system of claim 16, wherein the central computing system is further configured to store a set of promoted business destinations and identify whether at least one of the set of promoted business destinations corresponds to the request.
